(19) United States
(12) Patent Application Publication
(10) Pub. No.: US 2026/0196920 A1
(43) Pub. Date: Jul. 9, 2026

(54) CURRENT CONVERSION DEVICE

(71) Applicant: LITE-ON TECHNOLOGY CORPORATION, Taipei (TW)

(72) Inventors: Yu-Cheng LIN, Taipei (TW); Te-Hung YU, Taipei (TW); Chu-Hua HUANG, Taipei (TW)

(21) Appl. No.: 19/421,958

(22) Filed: Dec. 16, 2025

Related U.S. Application Data
(60) Provisional application No. 63/742,890, filed on Jan. 8, 2025.

(30) Foreign Application Priority Data
Nov. 17, 2025 (CN) 202522428860.1

(51) Int. Cl. H02M 1/00; H02M 1/084; H02M 3/00; H02M 3/335

(52) U.S. Cl. CPC H02M 1/007; H02M 1/084; H02M 3/01; H02M 3/33592

(57) ABSTRACT

A current conversion device includes a first conversion unit, a second conversion unit, a first passive element assembly and a second passive element assembly. The second conversion unit is electrically coupled to the first conversion unit. The first passive element assembly electrically couples the first conversion unit with the second conversion unit. The second passive element assembly electrically couples the first passive element assembly with the second conversion unit. The second passive element assembly is electrically and magnetically coupled to the first passive element assembly.

This application claims the benefit of U.S. provisional application Ser. No. 63/742,890, filed Jan. 8, 2025, the subject matter of which is incorporated herein by reference, and claims the benefit of People's Republic of China application Serial No. 202522428860.1, filed on Nov. 17, 2025, the subject matter of which is incorporated herein by reference.

### BACKGROUND OF THE INVENTION

### Field of the Invention

The invention relates in general to a current conversion device.

### Description of the Related Art

A key factor in server power supply design is how to achieve high-efficiency power conversion. A High-efficiency power conversion means less energy waste and lower operating costs. Therefore, how to develop a high-efficiency power conversion device is one of the goals of companies in this field.

### SUMMARY OF THE INVENTION

According to an embodiment of the present invention, a current conversion device is provided. The current conversion device includes a first conversion unit, a second conversion unit, a first passive element group and a second passive element group. The second conversion unit is electrically coupled to the first conversion unit. The first passive element group is electrically coupled between the first conversion unit and the second conversion unit. The second passive element group is electrically coupled between the first conversion unit and the second conversion unit. The second passive element group is electrically coupled and/or magnetically coupled to the first passive element group.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 illustrates a functional block diagram of a current conversion device according to an embodiment of the present invention;

FIG. 2A shows a circuit diagram of a current conversion device according to a first embodiment of this invention;

FIG. 2B shows a schematic diagram of a control timing of a plurality of switches and a voltage timing of a first winding coil/a second inductor of the current conversion device in FIG. 2A;

FIG. 3A shows a circuit diagram of the current conversion device according to the second embodiment of the present invention;

FIG. 3B shows a schematic diagram of the control timing of switches and the voltage timing of the first winding coil of the current conversion device in FIG. 3A;

FIG. 4A shows a circuit diagram of the current conversion device according to a third embodiment of the present invention;

FIG. 4B shows a control timing diagram of switches of the current conversion device in FIG. 4A; and

FIG. 4C shows a timing diagram of voltages and currents in FIG. 4A.

### DETAILED DESCRIPTION OF THE INVENTION

Unless otherwise defined, all terms used herein (including technical and scientific terms) have the same meaning as commonly understood by one of ordinary skill in the art to which this invention pertains. It will be further understood that terms such as those defined in commonly used dictionaries should be interpreted as having the same meaning as they have in the context of the relevant art and this invention, and they will not be interpreted as having an idealized or overly formal meaning unless expressly defined herein.

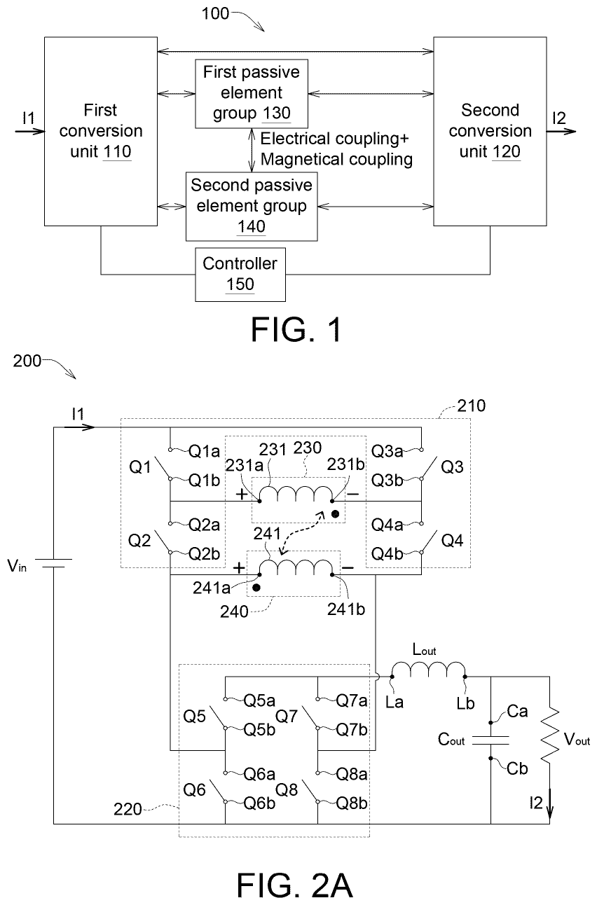

Refer to FIG. 1, FIG. 1 illustrates a functional block diagram of a current conversion device 100 according to an embodiment of the present invention. The current conversion device 100 includes a first conversion unit 110, a second conversion unit 120, a first passive element group 130, a second passive element group 140 and a controller 150. The second conversion unit 120 is electrically coupled to the first conversion unit 110. The first passive element group 130 is electrically coupled between the first conversion unit 110 and the second conversion unit 120. The second passive element group 140 is electrically coupled between the first conversion unit 110 and the second conversion unit 120. The second passive element group 140 is electrically and/or magnetically coupled to the first passive element group 130. As a result, a first current I1 received by the first conversion unit 110 may be converted into a second current I2 by the second conversion unit 120, wherein the first current I1 and the second current I2 are different from each other.

In an embodiment, the current conversion device 100 is a DC-to-DC converter, and the first current I1 and the second current I2 are, for example, direct current. In another embodiment, the first current I1 is greater than the second current I2, and the current conversion device 100 is a step-down device.

As shown in FIG. 1, the controller 150 is electrically connected to the first conversion unit 110 and the second conversion unit 120 for controlling the first conversion unit 110 and the second conversion unit 120 to convert the first current I1 into the second current I2. In an embodiment, the controller 150 may control the first conversion unit 110 and the second conversion unit 120 by using a pulse-width modulation (PWM) signal or a frequency-modulation signal.

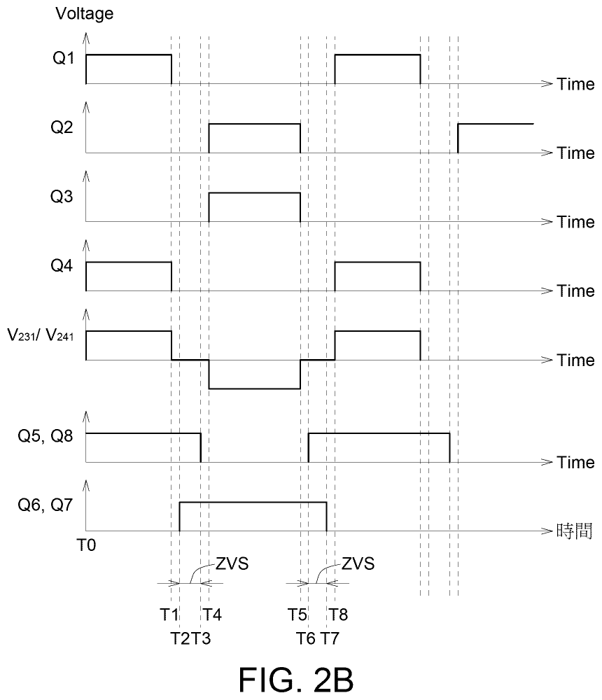

Referring to FIGS. 2A and 2B, FIG. 2A shows a circuit diagram of a current conversion device 200 according to a first embodiment of this invention, while FIG. 2B shows a schematic diagram of a control timing of a plurality of switches Q1 to Q8 and a voltage timing of a first winding coil 231/a second inductor 241 of the current conversion device 200 in FIG. 2A.

As shown in FIG. 2A, the current conversion device 200 includes a first conversion unit 210, a second conversion unit 220, a first passive element group 230, a second passive element group 240, an output inductor Lₒᵤₜ, an output capacitor Cₒᵤₜ and a controller 150 (not shown). The second conversion unit 220 is electrically coupled to the first conversion unit 210. The first passive element group 230 is electrically coupled to the first conversion unit 210 and the second conversion unit 220. The second passive element group 240 is electrically coupled to the first conversion unit 210 and the second conversion unit 220. The second passive element group 240 is electrically and magnetically (as shown by the dashed line in FIG. 2A) coupled to the first passive element group 230. As a result, the first current I1 received by the first conversion unit 210 may be converted into the second current I2 by the second conversion unit 220.

As shown in FIG. 2A, the first conversion unit 210 includes at least one switch, such as a first switch Q1, a second switch Q2, a third switch Q3 and a fourth switch Q4, wherein the first switch Q1 has a first terminal Q1a and a second terminal Q1b, the second switch Q2 has a first terminal Q2a and a second terminal Q2b, the third switch Q3 has a first terminal Q3a and a second terminal Q3b, and the fourth switch Q4 has a first terminal Q4a and a second terminal Q4b. The first terminal Q1a of the first switch Q1 is electrically coupled to the first terminal Q3a of the third switch Q3, and the second terminal Q1b of the first switch Q1 is electrically coupled to the first passive element group 230 and the first terminal Q2a of the second switch Q2. The first terminal Q2a of the second switch Q2 is electrically coupled to the second terminal Q1b of the first switch Q1 and the first passive element group 230, while the second terminal Q2b of the second switch Q2 is electrically coupled to the second passive element group 240 and the second conversion unit 220. The first terminal Q3a of the third switch Q3 is electrically coupled to the first terminal Q1a of the first switch Q1, while the second terminal Q3b of the third switch Q3 is electrically coupled to the first passive element group 230 and the first terminal Q4a of the fourth switch Q4. The first terminal Q4a of the fourth switch Q4 is electrically coupled to the second terminal Q3b of the third switch Q3 and the first passive element group 230, while the second terminal Q4b of the fourth switch Q4 is electrically coupled to the second passive element group 240 and the second conversion unit 220.

As shown in FIG. 2A, the second conversion unit 220 includes at least one switch, such as a fifth switch Q5, a sixth switch Q6, a seventh switch Q7 and an eighth switch Q8. The fifth switch Q5 has a first terminal Q5a and a second terminal Q5b, the sixth switch Q6 has a first terminal Q6a and a second terminal Q6b, the seventh switch Q7 has a first terminal Q7a and a second terminal Q7b, and the eighth switch Q8 has a first terminal Q8a and a second terminal Q8b. The first terminal Q5a of the fifth switch Q5 is electrically coupled to the first terminal Q7a of the seventh switch Q7 and the output inductor Lₒᵤₜ, while the second terminal Q5b of the fifth switch Q5 is electrically coupled to the first terminal Q6a of the sixth switch Q6 and the second terminal Q2b of the second switch Q2. The first terminal Q6a of the sixth switch Q6 is electrically coupled to the first terminal Q7a of the seventh switch Q7 and the output inductor Lₒᵤₜ, while the second terminal Q6b of the sixth switch Q6 is electrically coupled to the second terminal Q8b of the eighth switch Q8 and the output capacitor Cₒᵤₜ. The first terminal Q7a of the seventh switch Q7 is electrically coupled to the first terminal Q5a of the fifth switch Q5 and the output inductor Lₒᵤₜ, while the second terminal Q7b of the seventh switch Q7 is electrically coupled to the first terminal Q8a of the eighth switch Q8, the second passive element group 240 and the second terminal Q4b of the fourth switch Q4. The first terminal Q8a of the eighth switch Q8 is electrically coupled to the second terminal Q7b of the seventh switch Q7, the second passive element group 240, and the second terminal Q4b of the fourth switch Q4, while the second terminal Q8b of the eighth switch Q8 is electrically coupled to the second terminal Q6b of the sixth switch Q6 and the output capacitor Cₒᵤₜ.

As shown in FIG. 2A, the output inductor Lₒᵤₜ has a first terminal La and a second terminal Lb, wherein the first terminal La is electrically coupled to the first terminal Q5a of the fifth switch Q5 and the first terminal Q7a of the seventh switch Q7, and the second terminal Lb is electrically coupled to the output capacitor Cₒᵤₜ.

As shown in FIG. 2A, the output capacitor Cₒᵤₜ has a first terminal Ca and a second terminal Cb, wherein the first terminal Ca is electrically coupled to the second terminal Lb of the output inductor Lₒᵤₜ, and the second terminal Cb is electrically coupled to the second terminal Q6b of the sixth switch Q6 and the second terminal Q8b of the eighth switch Q8.

As shown in FIG. 2A, the first passive element group 230 includes a first winding coil (or “coupled inductor”) 231. The first winding coil 231 has a first terminal 231a and a second terminal 231b, wherein the first terminal 231a is electrically coupled to the second terminal Q1b of the first switch Q1 and the first terminal Q2a of the second switch Q2, and the second terminal 231b is electrically coupled to the second terminal Q3b of the third switch Q3 and the first terminal Q4a of the fourth switch Q4.

As shown in FIG. 2A, the second passive element group 240 includes a second winding coil 241. The second winding coil 241 has a first terminal 241a and a second terminal 241b, wherein the first terminal 241a is electrically coupled to the second terminal Q2b of the second switch Q2, the second terminal Q5b of the fifth switch Q5 and the first terminal Q6a of the sixth switch Q6, and the second terminal 241b is electrically coupled to the second terminal Q4b of the fourth switch Q4, the second terminal Q7b of the seventh switch Q7 and the first terminal Q8a of the eighth switch Q8.

As shown in FIG. 2B, in the present embodiment, the controller 150 (not shown) controls the first switch Q1 to the fourth switch Q4 of the first conversion unit 210 and the fifth switch Q5 to the eighth switch Q8 of the second conversion unit 220 using the pulse-width modulation (PWM) signal. The fifth switch Q5 to the eighth switch Q8 of the second conversion unit 220 operate in synchronous rectification mode to convert the first current I1 into the second current I2.

As shown in FIG. 2B, during the interval from time T0 to time T1, the first switch Q1 and the fourth switch Q4 of the first conversion unit 210 are turned on, the second switch Q2 and the third switch Q3 are turned off, the fifth switch Q5 and the eighth switch Q8 of the second conversion unit 220 are turned on, and the sixth switch Q6 and the seventh switch Q7 of the second conversion unit 220 are turned off. At this time, the voltage V₂₃₁ of the first winding coil 231 of the first passive element group 230 and the voltage V₂₄₁ of the second winding coil 241 of the second passive element group 240 are charged (for example, the first winding coil 231 and the second winding coil 241 are being energized).

As shown in FIG. 2B, during the interval from time T1 to time T2, the first switch Q1 and the fourth switch Q4 of the first conversion unit 210 are turned off, the second switch Q2 and the third switch Q3 of the first conversion unit 210 remain turned off, the fifth switch Q5 and the eighth switch Q8 of the second conversion unit 220 remain turned on, and the sixth switch Q6 and the seventh switch Q7 of the second conversion unit 220 remain turned off. At this time, the voltage V₂₃₁ of the first winding coil 231 of the first passive element group 230 and the voltage V₂₄₁ of the second winding coil 241 of the second passive element group 240 stop charging (for example, the first winding coil 231 and the second winding coil 241 stop being energized).

As shown in FIG. 2B, during the interval from time T2 to time T3, the first switch Q1, the second switch Q2, the third switch Q3 and the fourth switch Q4 of the first conversion unit 210 remain turned off, while the fifth switch Q5 and the eighth switch Q8 of the second conversion unit 220 remain turned on, and the sixth switch Q6 and the seventh switch Q7 of the second conversion unit 220 are turned on. Before the sixth switch Q6 and the seventh switch Q7 of the second conversion unit 220 are turned on, the first switch Q1 and the fourth switch Q4 of the first conversion unit 210 have already been turned off, thereby preventing the generation of reverse current. Furthermore, the interval from time T2 to time T3 is the zero-voltage switching (ZVS) region, and the fifth switch Q5, the sixth switch Q6, the seventh switch Q7 and the eighth switch Q8 of the second conversion unit 220 are all turned on. Through the ZVS, foldback can be achieved under higher input voltage and voltage drop, thereby increasing the switching frequency. During the zero-state period, the fifth switch Q5, the sixth switch Q6, the seventh switch Q7 and the eighth switch Q8 are in the turned-on state to improve conversion efficiency.

As shown in FIG. 2B, during the interval from time T3 to time T4, the first switch Q1, the second switch Q2, the third switch Q3 and the fourth switch Q4 of the first conversion unit 210 remain turned off, while the fifth switch Q5 and the eighth switch Q8 of the second conversion unit 220 are turned off, and the sixth switch Q6 and the seventh switch Q7 of the second conversion unit 220 remain turned on. At this time, the voltage V₂₃₁ of the first winding coil 231 of the first passive element group 230 and the voltage V₂₄₁ of the second winding coil 241 of the second passive element group 240 correspond to the discharge phase (for example, the energy stored in the first winding coil 231 and the second winding coil 241 is being released).

As shown in FIG. 2B, during the interval from time T5 to time T6, the first switch Q1, the second switch Q2, the third switch Q3 and the fourth switch Q4 of the first conversion unit 210 remain turned off, the fifth switch Q5 and the eighth switch Q8 of the second conversion unit 220 remain turned off, and the sixth switch Q6 and the seventh switch Q7 of the second conversion unit 220 remain turned on. At this time, the voltage V₂₃₁ of the first winding coil 231 of the first passive element group 230 and the voltage V₂₄₁ of the second winding coil 241 of the second passive element group 240 continue to discharging (for example, the first winding coil 231 and the second winding coil 241 continue to release their stored energy).

As shown in FIG. 2B, during the interval from time T6 to time T7, the first switch Q1, the second switch Q2, the third switch Q3 and the fourth switch Q4 of the first conversion unit 210 remain turned off, the fifth switch Q5 and the eighth switch Q8 of the second conversion unit 220 remain turned on, and the sixth switch Q6 and the seventh switch Q7 of the second conversion unit 220 remain turned on. The first switch Q1 and the fourth switch Q4 of the first conversion unit 210 remain turned off to prevent the generation of the reverse current. Furthermore, the interval from time T6 to time T7 is the zero-voltage switching (ZVS) region, and in zero-voltage switching region ZVS, the fifth switch Q5, the sixth switch Q6, the seventh switch Q7 and the eighth switch Q8 of the second conversion unit 220 are all turned on. Through the zero-voltage switching (ZVS) region, foldback can be achieved with a higher input voltage and voltage drop thereby increasing the switching frequency. During the zero-state period, the fifth switch Q5, the sixth switch Q6, the seventh switch Q7 and the eighth switch Q8 are turned on to improve conversion efficiency.

As shown in FIG. 2B, during the interval from time T7 to time T8, the first switch Q1, the second switch Q2, the third switch Q3 and the fourth switch Q4 of the first conversion unit 210 remain turned off, the fifth switch Q5 and the eighth switch Q8 of the second conversion unit 220 remain turned on, and the sixth switch Q6 and the seventh switch Q7 of the second conversion unit 220 are turned off. At this time, the voltage V₂₃₁ of the first winding coil 231 of the first passive element group 230 and the voltage V₂₄₁ of the second winding coil 241 of the second passive element group 240 stop charging (for example, the first winding coil 231 and the second winding coil 241 stop being energized).

In an embodiment, any of the switches described herein is, for example, a transistor switch, such as a metal-oxide-semiconductor field-effect transistor (MOSFET), such as a P-type MOSFET or an N-type MOSFET.

The input voltage Vᵢₙ and output voltage Vₒᵤₜ of FIG. 2A satisfy the following equation (1) for achieving a voltage reduction effect. In equation (1), N1 is the number of turns of the first winding coil 231, and N2 is the number of turns of the second winding coil 241.

$$\frac{{V}_{out}}{{V}_{in}} = \frac{N 2}{N 1 + N 2} \qquad ( 1 )$$

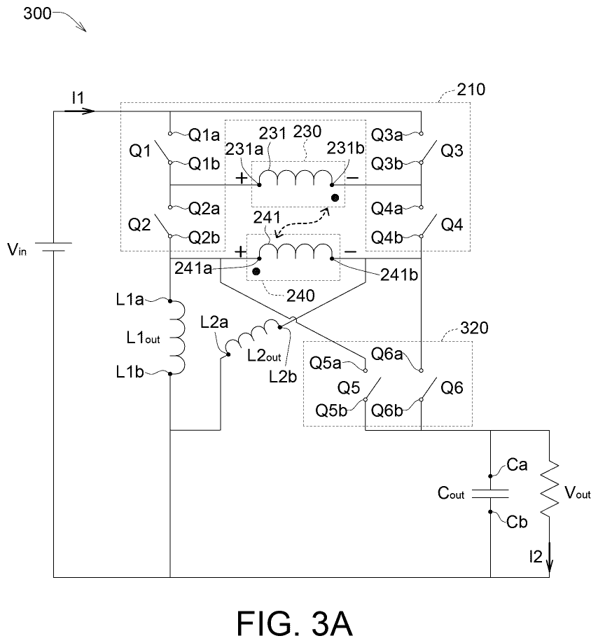

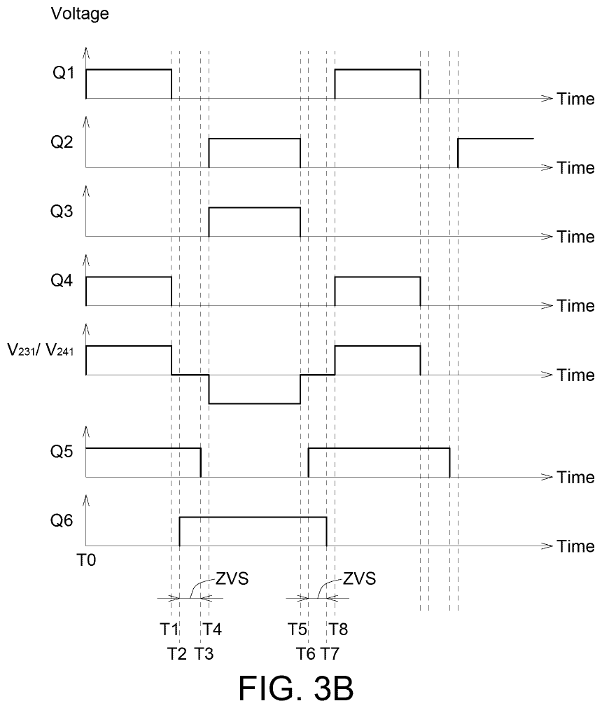

Referring to FIGS. 3A to 3B, FIG. 3A shows a circuit diagram of the current conversion device 300 according to the second embodiment of the present invention, and FIG. 3B shows a schematic diagram of the control timing of switches Q1 to Q6 and the voltage timing of the first winding coil 231 of the current conversion device 300 in FIG. 3A.

As shown in FIG. 3A, the current conversion device 300 includes the first conversion unit 210, a second conversion unit 320, the first passive element group 230, the second passive element group 240, a first output inductor L1ₒᵤₜ, a second output inductor L2ₒᵤₜ, the output capacitor Cₒᵤₜ and a controller 150 (not shown). The second conversion unit 320 is electrically coupled to the first conversion unit 110. The first passive element group 230 is electrically coupled to the first conversion unit 210 and the second conversion unit 320. The second passive element group 240 is electrically coupled to the first conversion unit 210 and the second conversion unit 320. The second passive element group 240 is electrically and magnetically (as shown by the dashed line in FIG. 3A) coupled to the first passive element group 230. As a result, the first current I1 received by the first conversion unit 210 may be converted into the second current I2 by the second conversion unit 320.

As shown in FIG. 3A, the first conversion unit 210 includes at least one switch, such as the first switch Q1, the second switch Q2, the third switch Q3 and the fourth switch Q4. The first switch Q1 has the first terminal Q1a and the second terminal Q1b, the second switch Q2 has the first terminal Q2a and the second terminal Q2b, the third switch Q3 has the first terminal Q3a and the second terminal Q3b, and the fourth switch Q4 has the first terminal Q4a and the second terminal Q4b. The first terminal Q1a of the first switch Q1 is electrically coupled to the first terminal Q3a of the third switch Q3. The second terminal Q1b of the first switch Q1 is electrically coupled to the first passive element group 230 and the first terminal Q2a of the second switch Q2. The first terminal Q2a of the second switch Q2 is electrically coupled to the second terminal Q1b of the first switch Q1 and the first passive element group 230, and the second terminal Q2b of the second switch Q2 is electrically coupled to the second passive element group 240 and the first output inductor L1ₒᵤₜ. The first terminal Q3a of the third switch Q3 is electrically coupled to the first terminal Q1a of the first switch Q1, while the second terminal Q3b of the third switch Q3 is electrically coupled to the first passive element group 230 and the first terminal Q4a of the fourth switch Q4. The first terminal Q4a of the fourth switch Q4 is electrically coupled to the second terminal Q3b of the third switch Q3 and the first passive element group 230, while the second terminal Q4b of the fourth switch Q4 is electrically coupled to the second passive element group 240, the second conversion unit 320 and the second output inductor L2ₒᵤₜ.

As shown in FIG. 3A, the second conversion unit 320 includes at least one switch, such as the fifth switch Q5 and the sixth switch Q6. Compared to the second conversion unit 220 of the current conversion device 200 in the previous embodiment, the second conversion unit 320 in this embodiment has fewer switches. The fifth switch Q5 has the first terminal Q5a and the second terminal Q5b, while the sixth switch Q6 has the first terminal Q6a and the second terminal Q6b. The first terminal Q5a of the fifth switch Q5 is electrically coupled to the second passive element group 240, the second terminal Q2b of the second switch Q2 and the first output inductor L1ₒᵤₜ. The second terminal Q5b of the fifth switch Q5 is electrically coupled to the second terminal Q6b of the sixth switch Q6 and the output capacitor Cₒᵤₜ. The first terminal Q6a of the sixth switch Q6 is electrically coupled to the second terminal Q4b of the fourth switch Q4, the second passive element group 240 and the second output inductor L2ₒᵤₜ. The second terminal Q6b of the sixth switch Q6 is electrically coupled to the second terminal Q5b of the fifth switch Q5 and the output capacitor Cₒᵤₜ.

As shown in FIG. 3A, the first passive element group 230 includes the first winding coil (coupled inductor) 231. The first winding coil 231 has the first terminal 231a and the second terminal 231b, wherein the first terminal 231a is electrically coupled to the second terminal Q1b of the first switch Q1 and the first terminal Q2a of the second switch Q2, and the second terminal 231b is electrically coupled to the second terminal Q3b of the third switch Q3 and the first terminal Q4a of the fourth switch Q4.

As shown in FIG. 3A, the second passive element group 240 includes the second winding coil 241. The second winding coil 241 has the first terminal 241a and a second terminal 241b, wherein the first terminal 241a is electrically coupled to the second terminal Q2b of the second switch Q2, the first output inductor L1ₒᵤₜ and the first terminal Q5a of the fifth switch Q5, and the second terminal 241b is electrically coupled to the second terminal Q4b of the fourth switch Q4, the first terminal Q6a of the sixth switch Q6, and the second output inductor L2ₒᵤₜ.

As shown in FIG. 3A, the first output inductor L1ₒᵤₜ has a first terminal L1a and a second terminal L1b. The first terminal L1a is electrically coupled to the second terminal Q2b of the second switch Q2, and the second terminal L1b is electrically coupled to the second output inductor L2ₒᵤₜ and the output capacitor Cₒᵤₜ. The second output inductor L2ₒᵤₜ has a first terminal L2a and a second terminal L2b. The first terminal L2a is electrically coupled to the second terminal L1b of the first output inductor L1ₒᵤₜ, and the second terminal L2b is electrically coupled to the second terminal 241b of the second winding coil 241, the second terminal Q4b of the fourth switch Q4 and the first terminal Q6a of the sixth switch Q6.

As shown in FIG. 3A, the output capacitor Cₒᵤₜ has a first terminal Ca and a second terminal Cb. The first terminal Ca is electrically coupled to the second terminal Q5b of the fifth switch Q5 and the second terminal Q6b of the sixth switch Q6, while the second terminal Cb is electrically coupled to the second terminal L1b of the first output inductor L1ₒᵤₜ and the first terminal L2a of the second output inductor L2ₒᵤₜ.

As shown in FIG. 3B, in the present embodiment, the controller 150 (not shown) controls the first switch Q1, the second switch Q2, the third switch Q3 and the fourth switch Q4 of the first conversion unit 210 and the fifth switch Q5 and the sixth switch Q6 of the second conversion unit 320 by using a pulse-width modulation signal. The fifth switch Q5 and the sixth switch Q6 of the second conversion unit 320 operate in synchronous rectification mode to convert the first current I1 into the second current I2.

As shown in FIG. 3B, during the interval from time T0 to time T1, the first switch Q1 and the fourth switch Q4 of the first conversion unit 210 are turned on, the second switch Q2 and the third switch Q3 of the first conversion unit 210 are turned off, the fifth switch Q5 of the second conversion unit 320 is turned on, and the sixth switch Q6 of the second conversion unit 320 is turned off. At this time, the voltage V₂₃₁ of the first winding coil 231 of the first passive element group 230 and the voltage V₂₄₁ of the second winding coil 241 of the second passive element group 240 are charged (for example, the first winding coil 231 and the second winding coil 241 are being energized).

As shown in FIG. 3B, during the interval from time T1 to time T2, the first switch Q1 and the fourth switch Q4 of the first conversion unit 210 are turned off, the second switch Q2 and the third switch Q3 of the first conversion unit 210 remain turned off, the fifth switch Q5 of the second conversion unit 320 remains turned on, and the sixth switch Q6 of the second conversion unit 320 remains turned off. At this time, the voltage V₂₃₁ of the first winding coil 231 of the first passive element group 230 and the voltage V₂₄₁ of the second winding coil 241 of the second passive element group 240 stop charging (for example, the first winding coil 231 and the second winding coil 241 stop being energized).

As shown in FIG. 3B, during the interval from time T2 to time T3, the first switch Q1, the second switch Q2, the third switch Q3 and the fourth switch Q4 of the first conversion unit 210 remain turned off, the fifth switch Q5 of the second conversion unit 320 remains turned on, and the sixth switch Q6 of the second conversion unit 320 is turned on. Before the sixth switch Q6 of the second conversion unit 320 is turned on, the first switch Q1 and the fourth switch Q4 of the first conversion unit 210 have already been turned off, thereby preventing the generation of reverse current. Furthermore, the interval from time T2 to time T3 is the zero-voltage switching (ZVS) region, in which both the fifth switch Q5 and the sixth switch Q6 of the second conversion unit 320 are turned on. Through the zero-voltage switching (ZVS) region, a higher input voltage and voltage drop can be used to achieve foldback, thereby increasing the switching frequency. During the zero-state period, the fifth switch Q5 and the sixth switch Q6 are in the turned-on state for improving conversion efficiency.

As shown in FIG. 3B, during the interval from time T3 to time T4, the first switch Q1, the second switch Q2, the third switch Q3 and the fourth switch Q4 of the first conversion unit 210 remain turned off, the fifth switch Q5 of the second conversion unit 320 is turned off, and the sixth switch Q6 of the second conversion unit 320 remains turned on. At this time, the voltage V₂₃₁ of the first winding coil 231 of the first passive element group 230 and the voltage V₂₄₁ of the second winding coil 241 of the second passive element group 240 correspond to the discharge phase (for example, the energy stored in the first winding coil 231 and the second winding coil 241 is being released).

As shown in FIG. 3B, during the interval from time T5 to time T6, the first switch Q1, the second switch Q2, the third switch Q3, and the fourth switch Q4 of the first conversion unit 210 remain turned off, the fifth switch Q5 of the second conversion unit 320 remains turned off, and the sixth switch Q6 of the second conversion unit 320 remains turned on. At this time, the voltage V₂₃₁ of the first winding coil 231 of the first passive element group 230 and the voltage V₂₄₁ of the second winding coil 241 of the second passive element group 240 continue to discharging (for example, the first winding coil 231 and the second winding coil 241 continue to release their stored energy).

As shown in FIG. 3B, during the interval from time T6 to time T7, the first switch Q1, the second switch Q2, the third switch Q3 and the fourth switch Q4 of the first conversion unit 210 remain turned off, while the fifth switch Q5 and the sixth switch Q6 of the second conversion unit 320 remain turned on. The first switch Q1 and the fourth switch Q4 of the first conversion unit 210 remain turned off to prevent the generation of reverse current. Furthermore, the interval from time T6 to time T7 is the zero-voltage switching (ZVS) region, and both the fifth switch Q5 and the sixth switch Q6 of the second conversion unit 320 are turned on. Through the zero-voltage switching (ZVS) region, a higher input voltage and voltage drop can be used to achieve foldback, thereby increasing the switching frequency. During the zero-state period, the fifth switch Q5 and the sixth switch Q6 are in the turned-on state to improve conversion efficiency.

As shown in FIG. 3B, during the interval from time T7 to time T8, the first switch Q1, the second switch Q2, the third switch Q3 and the fourth switch Q4 of the first conversion unit 210 remain turned off, the fifth switch Q5 of the second conversion unit 320 remains turned on, and the sixth switch Q6 of the second conversion unit 320 is turned off. At this time, the voltage V₂₃₁ of the first winding coil 231 of the first passive element group 230 and the voltage V₂₄₁ of the second winding coil 241 of the second passive element group 240 stop charging (for example, the first winding coil 231 and the second winding coil 241 stop being energized).

The input voltage Vᵢₙ and the output voltage Vₒᵤₜ in FIG. 3A satisfy the following equation (2) for achieving the voltage reduction effect. In equation (2), N1 is the number of turns of the first winding coil 231, and N2 is the number of turns of the second winding coil 241.

$$\frac{{V}_{out}}{{V}_{in}} = \frac{N 2}{N 1 \times 2 + N 2} \qquad ( 2 )$$

As described above, the current conversion device 200 of the first embodiment and the current conversion device 300 of the second embodiment are non-isolated DC-DC current conversion devices with high-efficiency PWM control mode. Through valley switching and low RDS(ON) switching power devices, the high-efficiency current conversion is achieved. Such two novel DC-DC current conversion devices may be applied to high-efficiency and high-density AI (Artificial Intelligence) server power supplies.

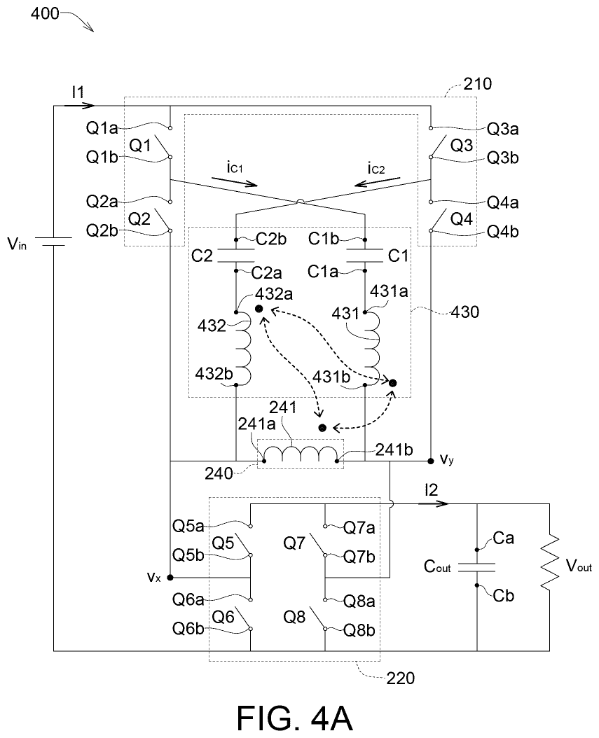

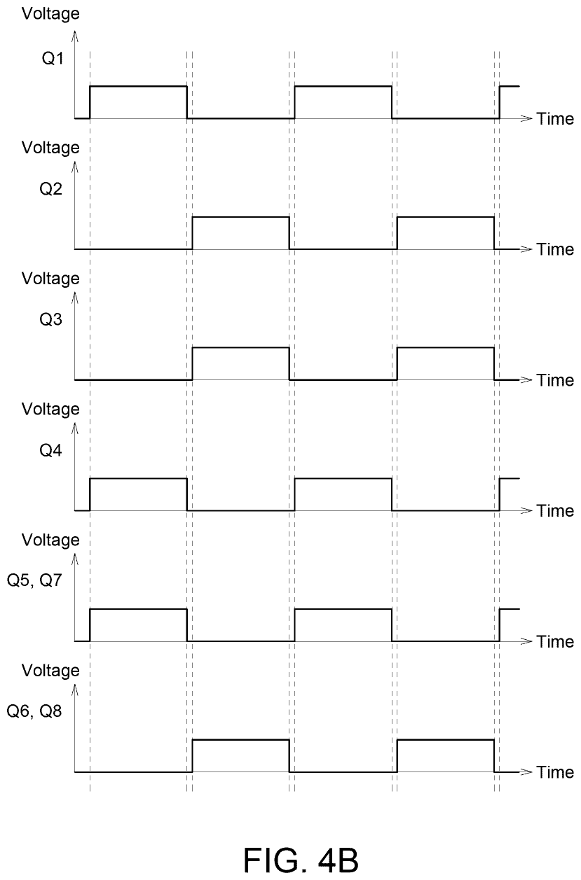

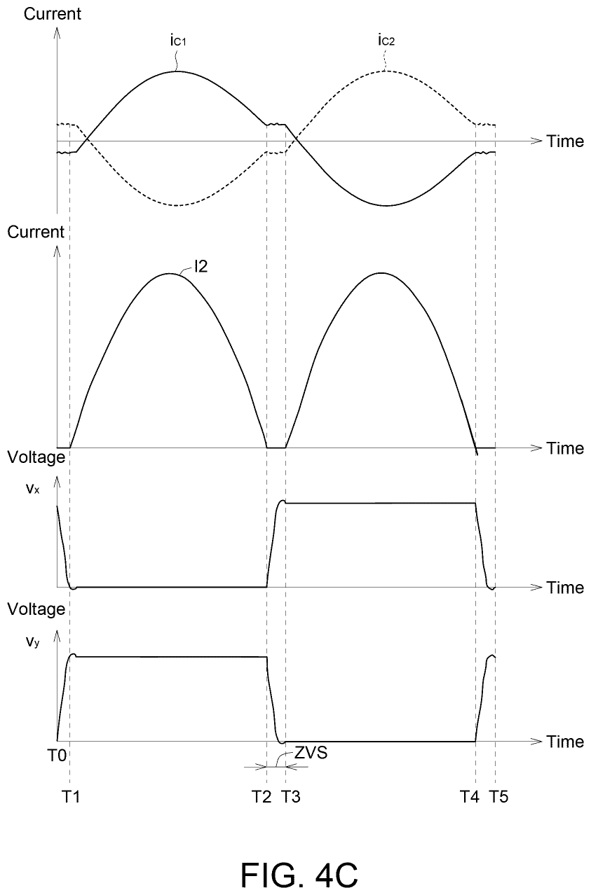

Referring to FIGS. 4A to 4C, FIG. 4A shows a circuit diagram of the current conversion device 400 according to a third embodiment of the present invention, FIG. 4B shows a control timing diagram of switches Q1 to Q8 of the current conversion device 400 in FIG. 4A, and FIG. 4C shows a timing diagram of a voltage Vx, a voltage Vy, a current i_{C1}, a current i_{C2}, and a second current I2 in FIG. 4A.

As shown in FIG. 4A, the current conversion device 400 includes the first conversion unit 210, the second conversion unit 220, a first passive element group 430, the second passive element group 240, the output capacitor Cₒᵤₜ and a controller 150 (not shown). The second conversion unit 220 is electrically coupled to the first conversion unit 210. The first passive element group 430 is electrically coupled to both the first conversion unit 210 and the second conversion unit 220. The second passive element group 240 is electrically coupled to both the first conversion unit 210 and the second conversion unit 220. The second passive element group 240 is electrically and magnetically (as shown by the dashed lines in FIG. 4A) coupled to the first passive element group 430. As a result, the first current I1 received by the first conversion unit 210 may be converted into the second current I2 by the second conversion unit 220.

As shown in FIG. 4A, the first conversion unit 210 includes at least one switch, such as the first switch Q1, the second switch Q2, the third switch Q3 and the fourth switch Q4. The first switch Q1 has the first terminal Q1a and the second terminal Q1b, the second switch Q2 has the first terminal Q2a and the second terminal Q2b, the third switch Q3 has the first terminal Q3a and the second terminal Q3b, and the fourth switch Q4 has the first terminal Q4a and the second terminal Q4b. The first terminal Q1a of the first switch Q1 is electrically coupled to the first terminal Q3a of the third switch Q3, and the second terminal Q1b of the first switch Q1 is electrically coupled to the first terminal Q2a of the second switch Q2 and the first passive element group 430. The first terminal Q2a of the second switch Q2 is electrically coupled to the second terminal Q1b of the first switch Q1 and the first passive element group 430, and the second terminal Q2b of the second switch Q2 is electrically coupled to the second passive element group 240 and the second conversion unit 220. The first terminal Q3a of the third switch Q3 is electrically coupled to the first terminal Q1a of the first switch Q1, and the second terminal Q3b of the third switch Q3 is electrically coupled to the first passive element group 430 and the first terminal Q4a of the fourth switch Q4. The first terminal Q4a of the fourth switch Q4 is electrically coupled to the second terminal Q3b of the third switch Q3 and the first passive element group 430, and the second terminal Q4b of the fourth switch Q4 is electrically coupled to the second conversion unit 220, the second passive element group 240, and the first passive element group 430.

As shown in FIG. 4A, the second conversion unit 220 includes at least one switch, such as the fifth switch Q5, the sixth switch Q6, the seventh switch Q7 and the eighth switch Q8. The fifth switch Q5 has the first terminal Q5a and the second terminal Q5b, the sixth switch Q6 has the first terminal Q6a and the second terminal Q6b, the seventh switch Q7 has the first terminal Q7a and the second terminal Q7b, and the eighth switch Q8 has the first terminal Q8a and the second terminal Q8b. The first terminal Q5a of the fifth switch Q5 is electrically coupled to the first terminal Q7a of the seventh switch Q7 and the output capacitor Cₒᵤₜ, while the second terminal Q5b of the fifth switch Q5 is electrically coupled to the first terminal Q6a of the sixth switch Q6, the second passive element group 240, the first passive element group 430 and the second terminal Q2b of the second switch Q2. The first terminal Q6a of the sixth switch Q6 is electrically coupled to the second terminal Q5b of the fifth switch Q5, the second terminal Q2b of the second switch Q2 and the second passive element group 240, while the second terminal Q6b of the sixth switch Q6 is electrically coupled to the second terminal Q8b of the eighth switch Q8 and the output capacitor Cₒᵤₜ. The first terminal Q7a of the seventh switch Q7 is electrically coupled to the first terminal Q5a of the fifth switch Q5 and the output capacitor Cₒᵤₜ. The second terminal Q7b of the seventh switch Q7 is electrically coupled to the first terminal Q8a of the eighth switch Q8, the second passive element group 240, the first passive element group 430 and the second terminal Q4b of the fourth switch Q4. The first terminal Q8a of the eighth switch Q8 is electrically coupled to the second terminal Q7b of the seventh switch Q7, the second terminal Q4b of the fourth switch Q4, the first passive element group 430 and the second passive element group 240. The second terminal Q8b of the eighth switch Q8 is electrically coupled to the second terminal Q6b of the sixth switch Q6 and the output capacitor Cₒᵤₜ.

As shown in FIG. 4A, the first passive element group 430 includes first winding coils 431 and 432, a first capacitor C1 and a second capacitor C2. The first winding coil 431 has a first terminal 431a and a second terminal 431b, the first winding coil 432 has a first terminal 432a and a second terminal 432b, the first capacitor C1 has a first terminal C1a and a second terminal C1b, and the second capacitor C2 has a first terminal C2a and a second terminal C2b. The first terminal 431a of the first winding coil 431 is electrically coupled to the first terminal C1a of the first capacitor C1, and the second terminal 431b of the first winding coil 431 is electrically coupled to the second passive element group 240, the second terminal Q4b of the fourth switch Q4, the second terminal Q7b of the seventh switch Q7, and the first terminal Q8a of the eighth switch Q8. The first terminal 432a of the first winding coil 432 is electrically coupled to the first terminal C2a of the second capacitor C2, while the second terminal 432b of the first winding coil 432 is electrically coupled to the second passive element group 240, the second terminal Q2b of the second switch Q2, the second terminal Q5b of the fifth switch Q5, and the first terminal Q6a of the sixth switch Q6. The first terminal C1a of the first capacitor C1 is electrically coupled to the first terminal 431a of the first winding coil 431, while the second terminal C1b of the first capacitor C1 is electrically coupled to the second terminal Q1b of the first switch Q1 and the first terminal Q2a of the second switch Q2. The first terminal C2a of the second capacitor C2 is electrically coupled to the first terminal 432a of the first winding coil 432, and the second terminal C2b of the second capacitor C2 is electrically coupled to the second terminal Q3b of the third switch Q3 and the first terminal Q4a of the fourth switch Q4.

As shown in FIG. 4A, the first capacitor C1 and the first winding coil 431 may form a first resonant tank, while the second capacitor C2 and the first winding coil 432 may form a second resonant tank.

As shown in FIG. 4A, the second passive element group 240 includes the second winding coil 241, wherein the second winding coil 241 has the first terminal 241a and a second terminal 241b. The first terminal 241a is electrically coupled to the second terminal 432b of the first winding coil 432, the second terminal Q2b of the second switch Q2, the second terminal Q5b of the fifth switch Q5 and the first terminal Q6a of the sixth switch Q6. The second terminal 241b is electrically coupled to the second terminal 431b of the first winding coil 431, the second terminal Q4b of the fourth switch Q4, the second terminal Q7b of the seventh switch Q7 and the first terminal Q8a of the eighth switch Q8.

As shown in FIG. 4B, in the present embodiment, the controller 150 (not shown) controls the first switch Q1, the second switch Q2, the third switch Q3 and the fourth switch Q4 of the first conversion unit 210 and the fifth switch Q5, the sixth switch Q6, the seventh switch Q7 and the eighth switch Q8 of the second conversion unit 220 with the frequency-modulation signal to convert the first current I1 into the second current I2 and obtain the zero-voltage switching (ZVS) region (the zero-voltage switching region ZVS is shown in FIG. 4C). The zero-voltage switching (ZVS), foldback can be achieved under the higher input voltage and voltage drop, thereby increasing the switching frequency. As shown in FIG. 4C, a current i_{C1} is the current flowing through the first capacitor C1 and the first winding coil 431, while a current i_{C2} is the current flowing through the second capacitor C2 and the first winding coil 432, and the output current I2 is the final output current.

As shown in FIG. 4A, the input voltage Vᵢₙ and output voltage Vₒᵤₜ satisfy the following equation (3) for achieving the voltage reduction effect. In equation (3), N1 is the number of turns of the first winding coil 431, the number of turns of the first winding coil 432 may be equal to the number of turns of the first winding coil 431, and N2 is the number of turns of the second winding coil 241.

$$\frac{{V}_{out}}{{V}_{in}} = \frac{N 1}{2 \times N 2} \qquad ( 3 )$$

As described in the third embodiment above, the current conversion device 400 is a non-isolated DC-DC converter with the high-efficiency frequency-modulation mode, and it achieves the high-efficiency current conversion through the zero-voltage switching and low on-resistance (RDS(ON)) switching power device. This type of DC-DC converter may be applied to the AI server power supply with the high-efficiency and high-density.

As shown in FIG. 4C, during the time interval T0 to T1, the voltage Vx decreases from a high level to a low level (e.g., zero voltage level), the voltage Vy increases from the low level (e.g., zero voltage level) to the high level, wherein the current i_{C1}, the current i_{C2} and the second current I2 remain unchanged.

As shown in FIG. 4C, during the time interval T1 to T2, the voltage Vx and the voltage Vy remain unchanged, the current i_{C1} and the current I2 exhibit positive half-cycle changes, while the current i_{C2} exhibits a negative half-cycle change.

As shown in FIG. 4C, during the time interval T2 to T3, the voltage Vx increases from the low level to the high level, and the voltage Vy decreases from the high level to the low level, wherein the current i_{C1}, the current i_{C2} and the second current I2 remain unchanged.

As shown in FIG. 4C, during the time interval T3 to T4, the voltage Vx and the voltage Vy remain unchanged, the current i_{C1} exhibits the negative half-cycle change, while currents i_{C2} and the second current I2 exhibit the positive half-cycle change.

As shown in FIG. 4C, during the time interval T4 to T5, the voltage Vx decreases from the high level to the low level, the voltage Vy increases from the low level to the high level, wherein the current i_{C1}, the current i_{C2} and the second current I2 remain unchanged.

In summary, the present embodiment proposes a current conversion device including two conversion units and two passive element groups. One of the two passive element groups is electrically coupled to the two conversion units, and another of the two passive element groups is electrically coupled to the two conversion units, and two passive element groups are electrically and magnetically coupled to each other. As a result, a first current received by one of the two conversion units may be converted into a second current by the other of the two conversion units, wherein the first current and the second current are different.

While the invention has been described by way of example and in terms of the preferred embodiment(s), it is to be understood that the invention is not limited thereto. Based on the technical features embodiments of the present invention, a person ordinarily skilled in the art will be able to make various modifications and similar arrangements and procedures without breaching the spirit and scope of protection of the invention. Therefore, the scope of protection of the present invention should be accorded with what is defined in the appended claims.

What is claimed is:

1. A current conversion device, comprising:
a first conversion unit;
a second conversion unit electrically coupled to the first conversion unit;
a first passive element group electrically coupled between the first conversion unit and the second conversion unit; and
a second passive element group electrically coupled between the first conversion unit and the second conversion unit;
wherein the second passive element group is electrically coupled and/or magnetically coupled to the first passive element group.

2. The current conversion device according to claim 1, further comprising:
a controller electrically connected to the first conversion unit and the second conversion unit and configured to:
control the first conversion unit and the second conversion unit with a pulse-width modulation (PWM) signal or a frequency-modulation signal.

3. The current conversion device according to claim 1, wherein the first conversion unit comprises a first switch, a second switch, a third switch, and a fourth switch, each of the first switch, the second switch, the third switch and fourth switch has a first terminal and a second terminal; the first terminal of the first switch is electrically coupled to the first terminal of the third switch; the second terminal of the first switch is electrically coupled to the first terminal of the second switch and the first passive element group; the second terminal of the third switch is electrically coupled to the first terminal of the fourth switch and the first passive element group; the second terminal of the second switch is electrically coupled to the second passive element group, and the second terminal of the fourth switch is electrically coupled to the second passive element group.

4. The current conversion device according to claim 1, wherein the second conversion unit comprises a fifth switch, a sixth switch, a seventh switch and an eighth switch, and each of the fifth switch, the sixth switch, the seventh switch and the eighth switch has a first terminal and a second terminal; the first terminal of the fifth switch is electrically coupled to the first terminal of the seventh switch; the second terminal of the fifth switch is electrically coupled to the first terminal of the sixth switch; the second terminal of the seventh switch is electrically coupled to the first terminal of the eighth switch; the second terminal of the sixth switch is electrically coupled to the second terminal of the eighth switch; the second terminal of the fifth switch and the first terminal of the sixth switch are electrically coupled to the first conversion unit, and the second terminal of the seventh switch and the first terminal of the eighth switch are electrically coupled to the first conversion unit.

5. The current conversion device according to claim 1, wherein the second conversion unit comprises a fifth switch and a sixth switch, and each of the fifth switch and the sixth switch has a first terminal and a second terminal; the second terminal of the fifth switch is electrically coupled to the second terminal of the sixth switch; the first terminal of the fifth switch is electrically coupled to the first conversion unit and the second passive element group, and the first terminal of the sixth switch is electrically coupled to the first conversion unit and the second passive element group.

6. The current conversion device according to claim 1, wherein the second conversion unit comprises a fifth switch, a sixth switch, a seventh switch and an eighth switch, and each of the fifth switch, the sixth switch, the seventh switch and the eighth switch has a first terminal and a second terminal; the second terminal of the fifth switch is electrically coupled to the first terminal of the sixth switch, the second terminal of the seventh switch is electrically coupled to the first terminal of the eighth switch, and the second terminal of the sixth switch is electrically coupled to the second terminal of the eighth switch.

7. The current conversion device according to claim 1, wherein the first passive element group comprises:
a capacitor having a first terminal and a second terminal, wherein the first terminal of the capacitor is electrically coupled to the first conversion unit; and
a first winding coil having a first terminal and a second terminal, wherein the first terminal of the first winding coil is electrically coupled to the second terminal of the capacitor, and the second terminal of the first winding coil is electrically coupled to the second passive element group and the second conversion unit.

8. The current conversion device according to claim 1, wherein the second passive element group has a first terminal and a second terminal, the first passive element group comprises a first resonant tank and a second resonant tank, the first resonant tank is electrically coupled to the first conversion unit and the second terminal of the second passive element group, and the second resonant tank is electrically coupled to the first conversion unit and the first terminal of the second passive element group.

9. The current conversion device according to claim 8, wherein the first conversion unit comprises a first switch, a second switch, a third switch and a fourth switch, and each of the first switch, the second switch, the third switch and the fourth switch has a first terminal and a second terminal; the first terminal of the first switch is electrically coupled to the first terminal of the third switch; the second terminal of the first switch is electrically coupled to the first terminal of the second switch and the first resonant tank of the first passive element group, and the second terminal of the third switch is electrically coupled to the first terminal of the fourth switch and the second resonant tank of the first passive element group.

10. The current conversion device according to claim 8, wherein the first resonant tank comprises a first capacitor and a first winding coil electrically coupled to the first capacitor, the second resonant tank comprises a second capacitor and a second winding coil electrically coupled to the second capacitor, the second terminal of the first switch is electrically coupled to the first capacitor of the first resonant tank of the first passive element group, and the second terminal of the third switch is electrically coupled to the second capacitor of the second resonant tank of the first passive element group.
